(19) United States
(12) Patent Application Publication
(10) Pub. No.: US 2015/0219389 A1
(43) Pub. Date: Aug. 6, 2015

(54) ILLUMINATING DISPLAY COOLER ASSEMBLY

(71) Applicant: iSee Store Innovations, LLC, St. Louis, MO (US)

(72) Inventors: Mark Schaefer, TOWN AND COUNTRY, MO (US); SESHA CHALAPATHI MADIREDDI, ST. CHARLES, MO (US); YE TIAM, MARYLAND HEIGHTS, MO (US)

(73) Assignee: iSee Store Innovations, LLC, St. Louis, MO (US)

(21) Appl. No.: 14/170,689

(22) Filed: Feb. 3, 2014

(51) Int. Cl. F25D 27/00; A47F 3/04; F21V 33/00

(52) U.S. Cl. CPC F25D 27/00; F21V 33/0044; A47F 3/0482; F21W 2131/405

(57) ABSTRACT

An illuminating display cooler assembly is configured to cool and display one or more products. The assembly may include a cover moveably secured to a main body. The cover is configured to be moved between an open position and a closed position over an internal chamber. At least one clear display panel is formed in the main body. The clear display panel(s) is configured to allow one or more products within the internal chamber to be viewed. At least one light-emitting member is configured to emit light into the internal chamber to enhance an appearance of the product(s) within the internal chamber. The light is diffracted by ice within the internal chamber.

### FIELD OF THE DISCLOSURE

Embodiments of the present disclosure generally relate to display cooler assemblies, and, more particularly, to illuminating display cooler assemblies.

### BACKGROUND OF THE DISCLOSURE

Various commercial enterprises offer goods for sale that may be contained within a transparent refrigeration container. For example, various convenience stores offer refreshments for sale. Some of the refreshments, such as soft drinks and beer, are refrigerated. Often, the refreshments are contained within a refrigerated compartment having a transparent door (formed of glass, for example). The transparent door allows a customer to see the types of refreshments that are available for sale. If the customer chooses to purchase a particular refreshment, the customer opens the door, removes the refreshment within the refrigerated compartment, and then closes the door.

However, commercial refrigerating systems may be large and expensive to acquire and operate. For example, a typical commercial refrigeration system may occupy a large volume of space within a store. Smaller stores may not have sufficient space for such a large system. Additionally, a typical commercial refrigeration system requires energy in order to properly function. The cost of supplying energy to such a system may be relatively expensive, particularly for small business owners. Further, large commercial refrigerating systems are often fixed and stationary. An operator is typically unable to quickly and easily move such a system within a particular location. Accordingly, typical commercial refrigerating systems may be too large and expensive for various business owners.

### SUMMARY OF THE DISCLOSURE

Certain embodiments of the present disclosure provide an illuminating display cooler assembly configured to cool and simultaneously display one or more products, such as cans or bottles containing beverages. The illuminating display cooler assembly may include a main body including a base connected to lateral walls, a front wall, and a rear wall. An internal chamber is defined between the base, the lateral walls, the front wall, and the rear wall. The internal chamber is configured to cool the product(s) with ice. A cover may be moveably secured to the main body. The cover is configured to be moved between an open position and a closed position over the internal chamber. At least one clear display panel is formed in one or more of the front wall, the lateral walls, or the rear wall. The clear display panel(s) is configured to allow the product(s) within the internal chamber to be viewed. At least one light-emitting member is configured to emit light into the internal chamber to enhance an appearance of the product(s) within the internal chamber. The light is diffracted by the ice within the internal chamber.

In at least one embodiment, the light-emitting member(s) is configured to be activated when the cover is in the closed position, and deactivated when the cover is in the open position. The assembly may include a switch operatively connected to the cover. The switch activates the light-emitting member(s) when the cover is closed, and deactivates the light-emitting member(s) when the cover is opened.

The light-emitting members may include a first light-emitting member secured to the base, and a second light-emitting member secured to the cover. The first and second light-emitting members are configured to emit light into the internal chamber. The first light-emitting member may be proximate to the clear display panel(s). The second light-emitting member may be proximate to a longitudinal center of the cover. Each of the light-emitting members may include one or more light emitting diodes (LEDs).

The clear display panel may include two parallel tempered glass panes separated by a space. The space may be filled with a clear insulator, such as an insulating gas, gel, liquid, plastic, or the like.

The assembly may also include a control unit operatively connected to the light-emitting member(s). The control unit may be configured to control operation of the light-emitting member(s).

The assembly may also include a refrigerating unit secured on or within a portion of the main body. The refrigerating unit is configured to cool the internal chamber.

### BRIEF DESCRIPTION OF THE DRAWINGS

FIG. 1 illustrates a perspective front view of an illuminating display cooler assembly, according to an embodiment of the present disclosure.

FIG. 2 illustrates a cross-sectional view of an illuminating display cooler assembly through line 2-2 of FIG. 1, according to an embodiment of the present disclosure.

FIG. 3 illustrates a cross-sectional view of a clear display panel through line 3-3 of FIG. 1, according to an embodiment of the present disclosure.

FIG. 4 illustrates a light-emitting member securely retained within a channel of a base of an illuminating display cooler assembly, according to an embodiment of the present disclosure.

FIG. 5 illustrates a perspective front view of a switch configured to be operatively engaged by a cover of an illuminating display cooler assembly, according to an embodiment of the present disclosure.

FIG. 6 illustrates a perspective rear view of an illuminating cooler assembly, according to an embodiment of the present disclosure.

FIG. 7 illustrates a perspective top view of an illuminating cooler assembly, according to an embodiment of the present disclosure.

FIG. 8 illustrates a perspective front view of an illuminating cooler assembly containing products and ice, according to an embodiment of the present disclosure.

FIG. 9 illustrates a simplified schematic diagram of an illuminating cooler assembly, according to an embodiment of the present disclosure.

Before the embodiments are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE DISCLOSURE

The foregoing summary, as well as the following detailed description of certain embodiments will be better understood when read in conjunction with the appended drawings. As used herein, an element or step recited in the singular and proceeded with the word “a” or “an” should be understood as not excluding plural of the elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

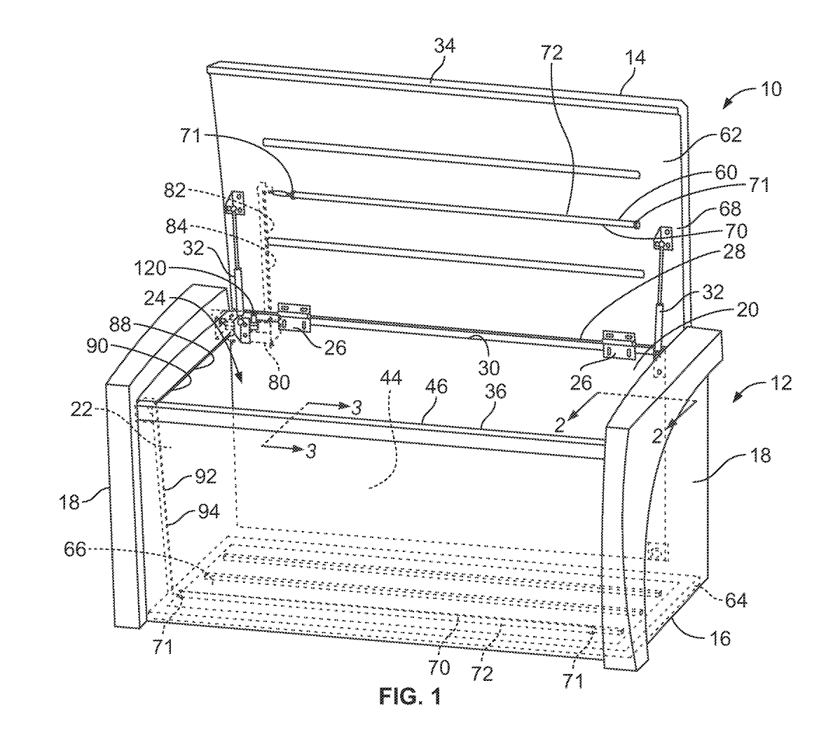

FIG. 1 illustrates a perspective front view of an illuminating display cooler assembly 10, according to an embodiment of the present disclosure. The assembly 10 includes a main body 12 and a cover 14 that may be pivotally secured to the main body 12. The main body 12 includes a base 16 integrally connected to lateral walls 18, a rear wall 20, and a front wall 22. The base 16, lateral walls 18, rear wall 20, and front wall 22 define an internal chamber 24. Products, such as beverages, and ice may be positioned within the internal chamber 24.

The cover 14 may be pivotally secured to the rear wall 20 through one or more hinges 26. For example, a rear edge 28 of the cover 14 may pivotally secure to an upper edge 30 of the rear wall 20 through the hinges 26. One or more motion-controlling members 32, such as pneumatic or hydraulic cylinders and pistons, may be connected between an inner surface of the rear wall 20 and a lower surface of the cover 14. For example, a motion-controlling member 32 may be located proximate to each lateral wall 18. The motion-controlling members 32 are configured to control the motion of the cover when opened and closed, and to prevent the cover 14 from being hyper-extended, for example. Alternatively, the assembly 10 may not include the motion-controlling members 32.

The cover 14 is configured to be moved between an open position, as shown in FIG. 1, and a closed position. In the closed position, a front edge 34 of the cover 14 may be grasped and pivoted toward a top edge 36 of the front wall 22. In the closed position, the front edge 34 of the cover 14 may seat over the top edge 36 of the front wall 22 in a sealing, fluid-tight relationship.

Alternatively, the cover 14 may connect to the main body 12 through various other types of connections. For example, the cover 14 may slide between open and closed positions over directions that are parallel to the base 16, for example. Also, alternatively, the cover 14 may snapably connect to the main body 12 and may be removed, such as by pulling up on the cover 14.

The cover 14, the lateral walls 18, the base 16, and the rear wall 20 may be formed of polyethylene. As an example, the cover 14, the lateral walls 18, the base 16, and the rear wall 20 may be formed of roto-molded polyethylene, having polyurethane foam insulation secured therein. For the sake of clarity, the cover 14, the lateral 18, the base 16, and the rear wall 20 are shown so that internal components of the assembly 10 are shown therethrough and/or therein. However, the cover 14, the lateral walls 18, the base 16, and the rear wall 20 may generally be solid and opaque.

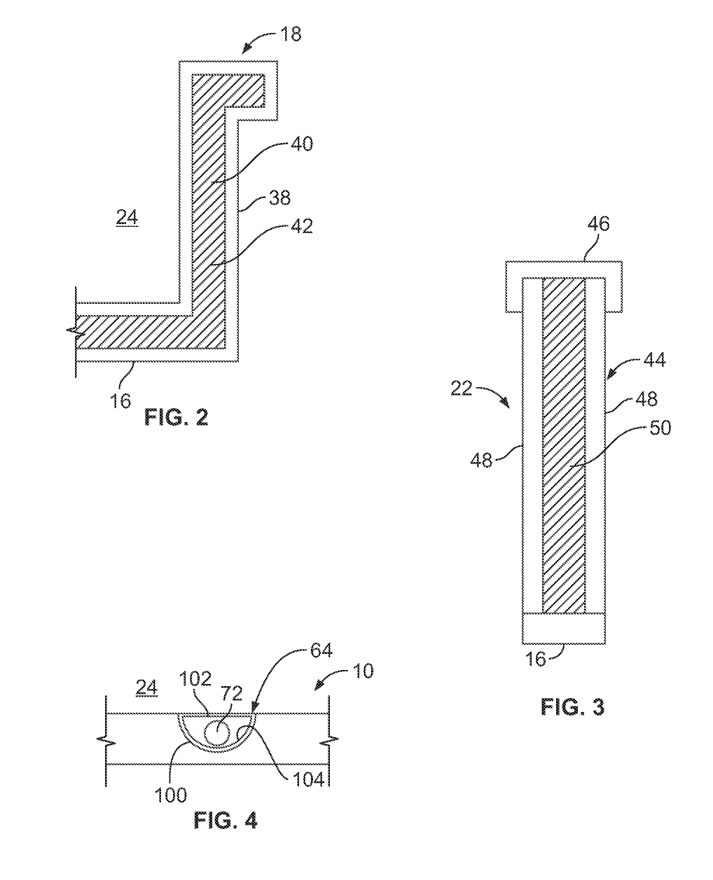

FIG. 2 illustrates a cross-sectional view of the illuminating display cooler assembly through line 2-2 of FIG. 1, according to an embodiment of the present disclosure. As shown, the lateral walls 18 and the base 16 (as well as the rear wall 20 and the cover 14) may include rigid walls 38 that define internal cavities 40. The rigid walls 38 may be formed of polyethylene, while the internal cavities 40 may be filled with insulating material 42, such as polyurethane foam insulation. Alternatively, the rigid walls may be formed of various other materials, such as acrylonitrile butadiene styrene (ABS), other types of styrene materials, or various other materials. Also, alternatively, instead of an internal cavity, the lateral walls 18 and the base 16 (as well as other portions of the main body 12), for example, may be formed of a solid piece of rigid material.

Referring again to FIG. 1, the front wall 22 of the assembly 10 includes a clear, transparent, translucent display panel 44 that allows an individual to view the contents of the assembly 10 from locations that are external thereto. That is, a user may look into the internal chamber 24 of the assembly 10 through the clear display panel 44. The clear display panel 44 may be secured within channels (hidden from view) formed within the base 16 and the lateral walls 18, for example, For example, edge portions of the clear display panel 44 may be securely retained within fluid-tight channels formed in the base 16 and the lateral walls 18. The clear display panel 44 connects to the base 16 and the lateral walls 18 in a sealed fashion, so that liquid, such as water, does not leak therethrough. An upper edge of the clear display panel 44 may be securely and sealingly connected to a horizontal bracket 46 that spans between the lateral walls 18. The front edge 34 of the cover 14 may seat over the bracket 46 in the closed position. Alternatively, the clear display panel 44 may not connect to a bracket, as shown in FIG. 1.

The clear display panel 44 may be formed of various clear, transparent, translucent materials that allow an individual to see into the internal chamber 24 of the assembly 10. For example, the clear display panel 44 may be formed of glass, plexi-glass, clear plastic, or the like.

FIG. 3 illustrates a cross-sectional view of the clear display panel 44 through line 3-3 of FIG. 1, according to an embodiment of the present disclosure. The clear display panel 44 may include two parallel upright glass panels 48 set apart from one another by a space 50. Each glass panel 48 may be formed of tempered glass, for example. The space 50 may be sealed so that gas or liquid may not enter therein, and any gas within the space 50 is prevented from escaping. The space 50 may be filled with a clear, insulating gas, such as Argon, for example. However, various other clear insulators may be used, such as other clear gases, liquids, gels, plastics, and/or the like. Alternatively, the clear display panel 44 may include more or less glass panels and spaces than shown. For example, the clear display panel 44 may include three glass panels and two spaces. Also, alternatively, the clear display panel 44 may include only a single pane of glass and no internal space. Additionally, each of the glass panels 48 may exhibit a wide range of thickness. One of the panels 48 may have a first thickness, while the other may have a second thickness that is different from the first thickness. The glass itself may be tempered, annealed, or untempered clear glass. The glass may be coated to improve the insulating properties of the assembly and/or to reduce or eliminate condensation on the glass.

Referring again to FIG. 1, the assembly 10 may include one or more light-emitting members configured to illuminate the internal chamber 24 in order to illuminate ice and products contained therein. As shown in FIG. 1, a light-emitting member 60 may be secured to and/or in a lower surface 62 of the cover 14, while a light-emitting member 64 may be secured to and/or in an interior surface 66 of the base 16.

The light-emitting member 60 may be secured to the lower surface 62 at a middle longitudinal area 68. As such, the light-emitting member 60 is configured to emit light over the internal chamber 24 so that the front and back of the internal chamber 24 may be evenly illuminated. Optionally, the light-emitting member 60 may be placed at a different location, such as closer to the front edge 34, if it is desired to provide increased light to the front of the internal chamber 24.

The light-emitting member 64 is secured to the base 16 at a front portion proximate to the clear display panel 44. As such, the light-emitting member 64 is configured to emit light up into the internal chamber 24 to illuminate and accentuate products and ice within the front of the internal chamber 24. Because the light-emitting member 64 is located at the front of the base 16, light emitted by the light-emitting member 64 brightly shines and diffracts through ice within the internal chamber, thereby providing an inviting, aesthetically-pleasing, and interesting view of the products within the internal chamber 24.

Each of the light-emitting member 60 and the light-emitting member 64 may include a fluid-tight strip 70 having fluid-tight caps 71 at either end. The fluid-tight strip 70 may include a clear portion through which light may pass. The fluid-right strip 70 may include a plurality of light-emitting elements 72, such as light-emitting diodes (LEDs).

The light-emitting member 60 is electrically connected to an electronics housing 80 secured to an outside of the rear wall 20. Note, while the rear wall 20 is shown in FIG. 1 as transparent, it is understood that this is for clarity. As noted above, the rear wall 20 may be a solid, opaque material.

The electronics housing 80 may be secured to various other portions of the assembly 10. For example, the electronics housing 80 may be secured within a fluid-tight pocket formed within other portions of the main body 12. As another example, the electronics housing 80 may be secured to an outer surface of the cover 14.

The electronics housing 80 may include a battery (hidden from view) that provides electrical energy to the light emitting members 60 and 64. Optionally, the electronics housing 80 may be operatively connected to a source of electrical power through a plug, for example, that is configured to removably connect to a standard wall outlet.

The electronics housing 80 electrically connects to the light-emitting member 60 through an electrical wire 82 that passes through a channel 84 formed through the cover 14. After the electrical wire 82 is secured within the channel 84, the electrical wire 82 and the channel 84 may be covered with a sealing material, such as an injection molded plastic.

The electronics housing 80 also electrically connects to the light-emitting member 64 through an electrical wire 88 that passes through a horizontal channel 90 formed in the lateral wall 18. The electrical wire 88 connects to an electrical wire 92 that passes through a vertical channel 94 formed in the lateral wall 18. The electrical wire 92 connects to the light-emitting member 64. Again, the electrical wires 88, 92, and the channels 90 and 94 may be covered with a sealing material, such as injection molded plastic. The electrical wires 82, 88, and 92 and electrical connections within the assembly 10 are insulated and covered so that liquid may not infiltrate therein.

FIG. 4 illustrates the light-emitting member 64 securely retained within a channel 100 of the base 16 of the illuminating display cooler assembly 10, according to an embodiment of the present disclosure. The channel 100 may be formed in the base 16 so that an upper surface of the light-emitting member 64 is flush with respect to an upper surface of the base 16. In this manner, products may safely and securely rest over the light-emitting member 64 while being less susceptible to tipping over.

The light-emitting member 64 may include a clear, transparent, translucent top portion 102 and an opaque lower portion 104 nestled within the channel 100. The opaque lower portion 104 may include a reflective surface that reflects light emitting from a light-emitting element 72 into the internal chamber 24. The top portion 102 allows light that is emitted from the light-emitting element 72 to shine into the internal chamber 24.

The light-emitting member 60 secured to the cover 14 (shown in FIG. 1) may be similarly retained and configured in order to emit light into the internal chamber 24. Alternatively, the light-emitting members 60 and 64 may not be mounted within channels formed in the assembly 10. Instead, the light-emitting members 60 and 64 may simply be secured to surfaces of the assembly 10.

Referring again to FIG. 1, the light-emitting members 60 and 64 may include a plurality of light-emitting elements 72 within a fluid-tight sleeve or tube. Optionally, the light emitting members 60 and 64 may include a single light-emitting strip. As noted, the light-emitting members 60 and 64 may include one or more LEDs. Alternatively, the light-emitting members 60 and 64 may include various other light-emitting devices, such as incandescent or fluorescent light-emitting elements, phosphorescent or glowing elements, and/or the like.

In operation, products, such as beverages to be cooled, are placed within the internal chamber 24. Ice may then be placed within the internal chamber 24 to keep the products cooled. Once the cover 14 is closed, the light-emitting members 60 and 64 emit light into the internal chamber 24, thereby illuminating the products. A consumer may view the products through the clear display panel 44. The light emitted from the light emitting member 64 diffracts through the ice, providing an interesting, inviting, and aesthetically-pleasing display that accentuates and highlights the products within the internal chamber 24. The electronics housing 80 may include a switch that allows an individual to activate and deactivate the light-emitting members 60 and 64.

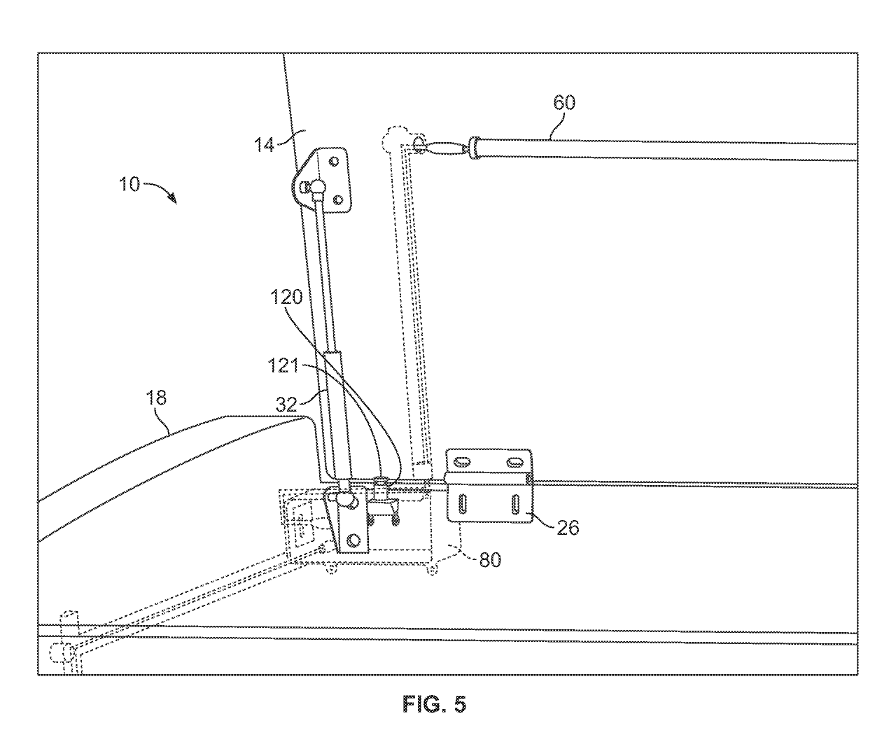

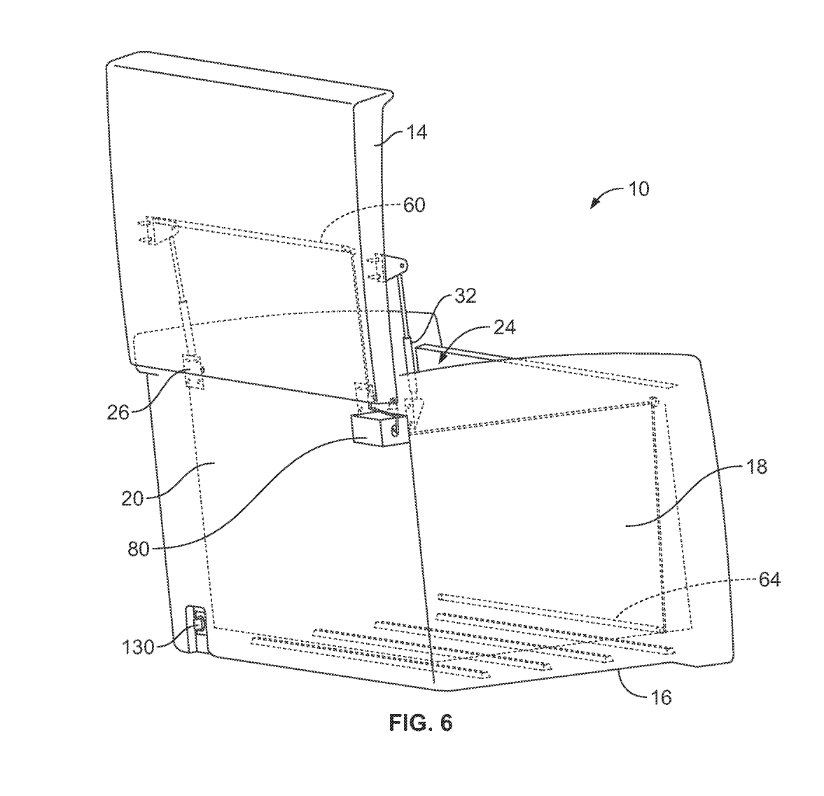

FIG. 5 illustrates a perspective front view of a switch 120 configured to be operatively engaged by the cover 14 of the illuminating display cooler assembly 10, according to an embodiment of the present disclosure. For example, the switch 120 may connect to the electronics housing 80 and may be configured to operatively engage the cover 14. The switch 120 may include a plunger 121 that depresses when the lower surface of the cover 14 closes over the plunger 121. For example, as the cover 14 is closed, the cover 14 engages the switch 120, which is depressed to close an electrical connection that activates the light-emitting members 60 and 64. When the cover 14 is opened, the cover 14 disengages from the switch 120, which then extends up, thereby opening the electrical connection, and deactivating the light-emitting members 60 and 64. In this manner, the light-emitting members 60 and 64 may be activated when the cover 14 is closed, and deactivated when the cover 14 is opened so that the light-emitting member 60 does not emit light directly into eyes of an individual attempting to gain access to the internal chamber 24.

Alternatively, instead of the switch 120, the assembly 10 may include an ON/OFF switch that is configured to be engaged by an individual. Also, alternatively, the assembly 10 may not include a separate and distinct switch. Instead, the light-emitting members 60 and 64 may be activated when connected to a source of electrical power (such as a battery or standard wall outlet), and deactivated when disconnected from the source of electrical power.

More or less light-emitting members may be used. For example, instead of just one light-emitting member 60 secured to the cover 14, two or more light-emitting members 60 may be secured to the cover. For example, two or three light-emitting members may span between sides of the cover 14, while additional perpendicularly-oriented light-emitting members may span between rear and front portions of the cover 14. Similarly, additional light-emitting members may be secured to the base 16 and configured to emit light into the internal chamber 24. Further, light-emitting members may be secured to internal surfaces of the lateral walls 18 and configured to emit light into the internal chamber 24.

Further, other portions of the assembly 10 may be clear, transparent, and translucent. For example, in addition to the clear front panel 44, portions of one or more of the lateral walls 18, the rear wall 20, and the cover 14 may also be formed of clear, transparent, and translucent material, as described above.

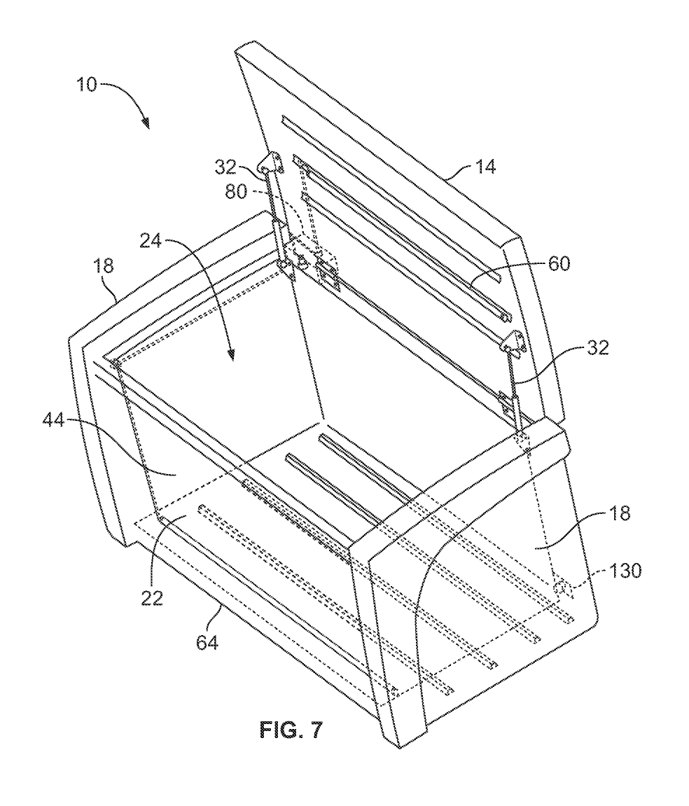

FIG. 6 illustrates a perspective rear view of the illuminating cooler assembly 10, according to an embodiment of the present disclosure. FIG. 7 illustrates a perspective top view of the assembly 10, according to an embodiment of the present disclosure. Referring to FIGS. 1, 6, and 7, the electronics housing 80 may be securely mounted to a rear surface of the rear wall 20. Additionally, a drain plug 130 may be removably secured to and through the rear wall 20 proximate to the base 16. The drain plug 130 may be removed in order to drain the internal chamber 24 of melt water, for example.

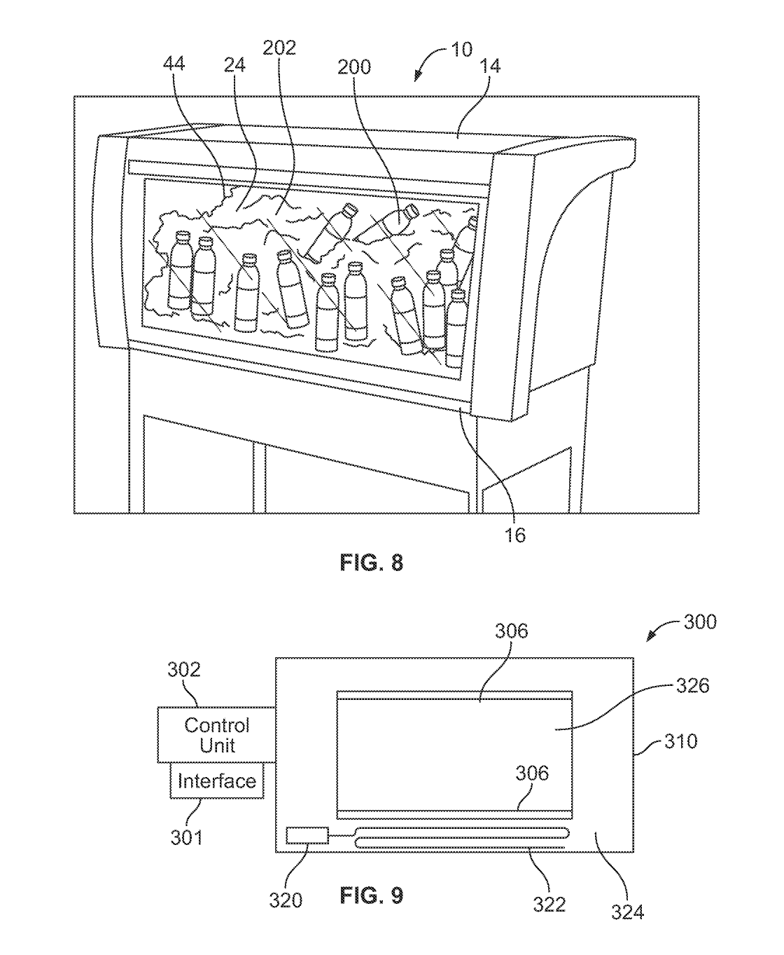

FIG. 8 illustrates a perspective front view of the illuminating cooler assembly 10 containing products 200 and ice 202, according to an embodiment of the present disclosure. When the cover 14 is closed, the light-emitting members, such as those described above, emit light into the internal chamber 24 that diffracts through the ice 202, thereby illuminating the internal chamber 24 and highlighting and accentuating the products 200 within the internal chamber 24. It has been found that placing the light-emitting members within the base 16 allows the light to pass through the ice 202 and diffract therethrough, which produces an aesthetically-pleasing illuminated display that makes the products 200 within the internal chamber 24 stand out. Because the light-emitting member 64 (as shown in FIG. 1) may be placed proximate to the front of the internal chamber 24, light is prominently and brightly emitted at the front of the internal chamber, thereby providing a brighter and bolder illuminated display of the products 200.

When the cover 14 is opened, the light-emitting members may be deactivated, such as through the switch 120, as described above. As such, the illuminating cooler assembly 10 may be illuminated when the cover 14 is closed. Further, the assembly 10 may be prevented from being illuminated when the cover 14 is opened, in order to protect bright light from directly shining into eyes of an individual who opened the cover 14.

The light-emitting members may emit white light into the internal chamber. Alternatively, the light-emitting members may emit various other colored light into the internal chamber. For example, the electronics housing 80 may include a control circuit or module that is operatively connected to the light-emitting members and programmed to vary the color of light emitted by the light-emitting members. Alternatively, a control interface may be connected to the electronics housing that allows an individual to change the color of light emitted by the light-emitting members. For example, the light-emitting members may include LEDs that may provide varying color light. The individual may program the electronics housing to vary the color of light emitted by the light-emitting members according to a schedule, for example.

FIG. 9 illustrates a simplified schematic diagram of an illuminating cooler assembly 300, according to an embodiment of the present disclosure. The assembly 300 may include the components described above. Additionally, the assembly 300 may include a control unit 302 operatively connected to one or more light-emitting members 306 and a control interface 304. The control unit 302 may be configured to control operation of the light-emitting members 306, such as emitted light color, intensity, brightness, and the like. A user may control operation of the light-emitting members 306 through the control interface 304, which may be or include a keyboard, buttons, a touchscreen, and/or the like. The control unit 302 and the control interface 304 may be mounted to the main housing 310 of the assembly 300. Alternatively, the control unit 302 and the control interface 304 may be remotely connected to the main housing 310, and communicate with the light-emitting members 306 through wired or wireless connections, for example.

The cooler assembly 300 may also include a refrigeration unit 320 that includes a refrigerating member 322, such as a refrigerating coil, sheet, layer, panel, or the like. The refrigerating member 322 may be embedded within the base 324 of the main housing 310, and/or disposed within an internal chamber 326. The refrigerating member 322 may be connected to a source of power. The refrigerating member 322 may circulate cold refrigerant therethrough in order to cool the internal chamber 326. While the refrigerating member 322 is shown within the base 324, the refrigerating member 322 may alternatively be secured in or on any other portion of the main housing 310, including lateral walls, the cover, or the rear wall, in place of, or in addition to, the base 324. The refrigerating unit 320 may be used to prolong the longevity of the ice within the internal chamber 326. For example, the refrigerating unit 320 may be activated to delay melting of the ice. Optionally, the refrigerating unit 320 may be used to cool the internal chamber 324 in place of ice.

A refrigerating unit, such as the refrigerating unit 320, may be used with any of the embodiments described above. For example, the illuminating cooler display assembly 10 shown and described with respect to FIGS. 1-8 may include the refrigerating unit 320 and refrigerating member 322, as described above.

The control unit 302 and the interface 304 may form, or be part of, a computer or module that is configured to control operation of the light-emitting members 306. As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer” or “module.”

The computer or processor executes a set of instructions that are stored in one or more storage elements, in order to process data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the module(s) may represent circuit modules that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the modules may represent processing circuitry such as one or more field programmable gate array (FPGA), application specific integrated circuit (ASIC), or microprocessor. The circuit modules in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

Referring to FIGS. 1-9, embodiments of the present disclosure provide illuminating display cooler assemblies that are configured to emit light into an internal chamber of the assembly in order to provide an aesthetically-inviting presentation of products within the assembly. Unlike large commercial refrigerating systems, which may be bulky, difficult to move, and expensive to acquire and operate, the illuminating display cooler assemblies described in the present application are portable, less obtrusive, and may consume far less energy as compared to traditional commercial refrigeration systems. In operation, an individual may simply place products within an internal chamber, fill the internal chamber with ice, and then close the cover and illuminate the assembly. As such, embodiments of the present disclosure provide a cost-effective system and method of displaying products, such as beverages, that are to be cooled, illuminated, and presented to consumers.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An illuminating display cooler assembly configured to cool and display one or more products, the illuminating display cooler assembly comprising:
a main body including a base connected to lateral walls, a front wall, and a rear wall, wherein an internal chamber is defined between the base, the lateral walls, the front wall, and the rear wall, and wherein the internal chamber is configured to cool the one or more products with ice;
a cover moveably secured to the main body, wherein the cover is configured to be moved between an open position and a closed position over the internal chamber;
at least one clear display panel formed in one or more of the front wall, the lateral walls, or the rear wall, wherein the at least one clear display panel is configured to allow the one or more products within the internal chamber to be viewed; and
at least one light-emitting member configured to emit light into the internal chamber to enhance an appearance of the one or more products within the internal chamber, and wherein the light is diffracted by the ice within the internal chamber.

2. The illuminating display cooler assembly of claim 1, wherein the at least one light-emitting member is configured to be activated when the cover is in the closed position, and wherein the at least one light-emitting member is configured to be deactivated when the cover is in the open position.

3. The illuminating display cooler assembly of claim 2, further comprising a switch operatively connected to the cover, wherein the switch activates the at least one light-emitting member when the cover is closed, and wherein the switch deactivates the at least one light-emitting member when the cover is opened.

4. The illuminating display cooler assembly of claim 1, wherein the at least one light-emitting member comprises:
a first light-emitting member secured to the base, wherein the first light-emitting member is configured to emit light upwardly into the internal chamber; and
a second light-emitting member secured to the cover, wherein the second light-emitting member is configured to emit light into the internal chamber.

5. The illuminating display cooler assembly of claim 4, wherein the first light-emitting member is proximate to the at least one clear display panel.

6. The illuminating display cooler assembly of claim 4, wherein the second light-emitting member is proximate to a longitudinal center of the cover.

7. The illuminating display cooler assembly of claim 1, wherein the at least one light-emitting member includes one or more light emitting diodes (LEDs).

8. The illuminating display cooler assembly of claim 1, wherein the at least one clear display panel includes two parallel tempered glass panes separated by a space, wherein the space is filled with a clear insulator.

9. The illuminating display cooler assembly of claim 1, further comprising a control unit operatively connected to the at least one light-emitting member, wherein the control unit is configured to control operation of the at least one light-emitting member.

10. The illuminating display cooler assembly of claim 1, further comprising a refrigerating unit secured on or within a portion of the main body, wherein the refrigerating unit is configured to cool the internal chamber.

11. An illuminating display cooler assembly configured to cool and display one or more products, the illuminating display cooler assembly comprising:
a main body including a base connected to lateral walls, a front wall, and a rear wall, wherein an internal chamber is defined between the base, the lateral walls, the front wall, and the rear wall, and wherein the internal chamber is configured to cool the one or more products are configured with ice;
a cover moveably secured to the main body, wherein the cover is configured to be moved between an open position and a closed position over the internal chamber;
a clear display panel formed in the front wall, wherein the clear display panel is configured to allow the one or more products within the internal chamber to be viewed; and
first and second light-emitting members configured to emit light into the internal chamber to enhance an appearance of the one or more products within the internal chamber, and wherein the light is diffracted by the ice within the internal chamber.

12. The illuminating display cooler assembly of claim 11, further comprising a switch operatively connected to the cover, wherein the first and second light-emitting members are configured to be activated when the cover is in the closed position, wherein the switch activates the first and second light-emitting members when the cover is closed, wherein the first and second light-emitting members are configured to be deactivated when the cover is in the open position, and wherein the switch deactivates the first and second light-emitting members when the cover is opened.

13. The illuminating display cooler assembly of claim 11, wherein the first light-emitting member is secured to the base and is configured to emit light upwardly into the internal chamber, and wherein the second light-emitting member is secured to the cover and is configured to emit light into the internal chamber.

14. The illuminating display cooler assembly of claim 13, wherein the first light-emitting member is proximate to the clear display panel, and wherein the second light-emitting member is proximate to a longitudinal center of the cover.

15. The illuminating display cooler assembly of claim 11, wherein each of the first and second light-emitting members includes one or more light emitting diodes (LEDs).

16. The illuminating display cooler assembly of claim 11, wherein the clear display panel includes two parallel tempered glass panes separated by a space, wherein the space is filled with a clear insulator.

17. The illuminating display cooler assembly of claim 11, further comprising a control unit operatively connected to the first and second light-emitting members, wherein the control unit is configured to control operation of the first and second light-emitting members.

18. The illuminating display cooler assembly of claim 11, further comprising a refrigerating unit secured on or within a portion of the main body, wherein the refrigerating unit is configured to cool the internal chamber.

19. An illuminating display cooler assembly configured to cool and display one or more products, the illuminating display cooler assembly comprising:
a main body including a base connected to lateral walls, a front wall, and a rear wall, wherein an internal chamber is defined between the base, the lateral walls, the front wall, and the rear wall, and wherein the internal chamber is configured to cool the one or more products are configured with ice;
a cover moveably secured to the main body, wherein the cover is configured to be moved between an open position and a closed position over the internal chamber;
a clear display panel formed in the front wall, wherein the clear display panel is configured to allow the one or more products within the internal chamber to be viewed;
a first light-emitting member secured to the base and proximate to the clear display panel, wherein the first light-emitting member is configured to emit light upwardly into the internal chamber to enhance an appearance of the one or more products within the internal chamber, wherein the light is diffracted by the ice within the internal chamber;
a second light-emitting member secured proximate to a longitudinal center of the cover, wherein the second-emitting member is configured to emit light downwardly into the internal chamber to enhance an appearance of the one or more products within the internal chamber; and
a switch operatively connected to the cover, wherein the first and second light-emitting members are configured to be activated when the cover is in the closed position, wherein the switch activates the first and second light-emitting members when the cover is closed, wherein the first and second light-emitting members are configured to be deactivated when the cover is in the open position, and wherein the switch deactivates the first and second light-emitting members when the cover is opened.

20. The illuminating display cooler assembly of claim 19, wherein each of the first and second light-emitting members includes one or more light emitting diodes (LEDs).

21. The illuminating display cooler assembly of claim 19, wherein the clear display panel includes two parallel tempered glass panes separated by a space, wherein the space is filled with a clear insulator.

22. The illuminating display cooler assembly of claim 19, further comprising a control unit operatively connected to the first and second light-emitting members, wherein the control unit is configured to control operation of the first and second light-emitting members.

23. The illuminating display cooler assembly of claim 19, further comprising a refrigerating unit secured on or within a portion of the main body, wherein the refrigerating unit is configured to cool the internal chamber.
